(19) United States
(12) Patent Application Publication
(10) Pub. No.: US 2016/0321691 A1
(43) Pub. Date: Nov. 3, 2016

(54) SYSTEM AND METHOD FOR REFRESHING TARGETED EMAILS

(71) Applicant: American Express Travel Related Services Company, Inc., New York, NY (US)

(72) Inventors: Simone O. Bott, Jersey City, NJ (US); Lionel Lafargue, Westbury, NY (US); Brian G. Lenhart, Berkeley Heights, NJ (US)

(73) Assignee: American Express Travel Related Services Company, Inc., New York, NY (US)

(21) Appl. No.: 14/936,129

(22) Filed: Nov. 9, 2015

Related U.S. Application Data
(60) Provisional application No. 62/154,673, filed on Apr. 29, 2015.

(51) Int. Cl. G06Q 30/02; H04L 29/08; H04L 12/58

(52) U.S. Cl. CPC G06Q 30/0255; H04L 51/14; H04L 67/06

(57) ABSTRACT

A transaction account provider may obtain travel information from a customer transaction. The travel information may include the date and destination of travel. An email service provider may transmit an email to the customer with an offer related to the date and destination of travel. In response to the customer opening the email, the email may be updated with current information regarding the offer.

### FIELD

The present disclosure relates to effective and targeted advertisement delivery based on changing data.

### BACKGROUND

In the online world, customer buying patterns and browsing patterns may be mined while the customer is using a web browser or shopping online. A great deal of resources are used to identify advertisements and offers best suited to a particular customer. After an offer is sent to the customer, information about the customer or available offers may change, such that a different offer may be better suited to the customer. However, if an offer was previously emailed to the customer, it may be difficult to present the new offer to the customer without bombarding the customer with additional emails.

### SUMMARY

A system, method, and computer readable medium (collectively, the “system”) is disclosed for transmitting targeted refreshable emails. The method may comprise obtaining transaction information for a transaction; transmitting the transaction information to an email communications platform via secure file transfer protocol; appending, at the email communications platform, an email address to the transaction information; transmitting, from the email communications platform to an email service provider, the transaction information and the email address via secure file transfer protocol; matching, by the email service provider, dynamic content with the transaction information; transmitting, from the email service provider, an email offer to a customer, wherein the email offer comprises the transaction information; and transmitting current offer information to the customer in response to the customer opening the email offer.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 illustrates an exemplary system for delivering targeted refreshable offers, in accordance with various embodiments;

FIG. 2 illustrates a method for delivering targeted refreshable offers, in accordance with various embodiments; and

FIG. 3 illustrates a specific example of a method for delivering targeted refreshable offers, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

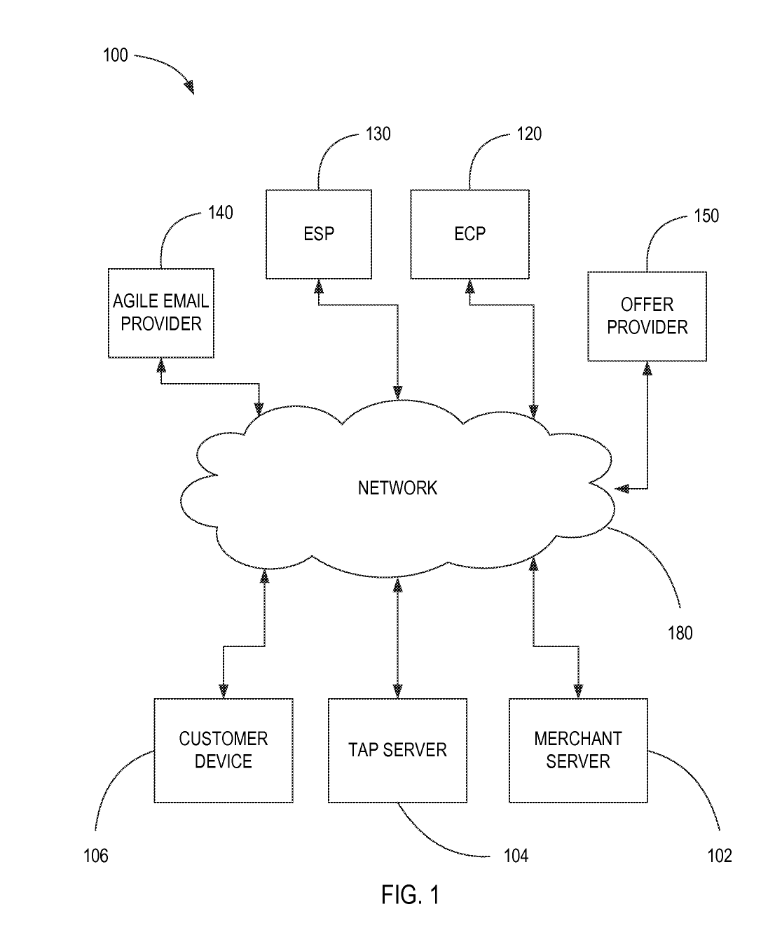

In various embodiments, and with reference to FIG. 1, a system 100 may be configured for obtaining customer information, transaction information, demographic information and/or merchant information and delivering offers related to any portion or all of the information. The offers may be targeted, customized, dynamic, updated, based on an algorithm, incremented and/or refreshable. The system and method may expedite processing (e.g., by having access to relevant information), reduce the need for excessive emails (e.g., by refreshing existing emails), and increase security (e.g., by limiting the number of emails with personal information).

The system 100 may comprise a merchant server 102. The merchant server 102 may be operated by, or affiliated with a merchant. The merchant server 102 may collect transaction information in response to customers completing purchases from the merchant, such as online, over the phone, or at a physical merchant store. The transaction information may include, for example, travel dates and locations for the purchase, a spend amount, merchant category, merchant name, store location, items purchased, purchase time, and/or past transaction information. In various embodiments, the merchant server 102 may collect transaction information from separate purchases by the customer at different times or locations.

In various embodiments, the system 100 may further comprise a transaction account provider (“TAP”) server 104. The TAP server 104 may comprise one or more computer systems in communication with the merchant server 102 over a network 108. The merchant server 102 may send transaction information collected during sales through the network 108 to the TAP server 104. The TAP server 104 may be maintained, for example, by a financial institution and/or transaction account provider. The merchant server 102 may contact the TAP server 104 maintained by the transaction account provider to authorize a transaction on a transaction account. During the authorization, transaction information may be transmitted to the TAP server 104. The TAP server 104 may use transaction information to authorize the transaction. Various intermediaries may be present between the merchant server 102 and the TAP server 104, such as a credit card processer or other third parties.

In various embodiments, the TAP server 104 may be hosted, for example, by a transaction account provider. Phrases and terms similar to “transaction account” may include any account that may be used to facilitate a financial transaction. Phrases and terms similar to “financial institution” or “transaction account provider” may be used interchangeably and include any entity that offers transaction account services (e.g., payment processor). Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The system 100 may further comprise an Email Communications Platform (“ECP”) 120. The ECP 120 may comprise a multi-tier architecture, which may include extract, transform, and load applications, and a database layer. The ECP 120 may store customer email addresses in a database. The ECP 120 may be configured to receive a list of customers and their respective customer information from the TAP server 104 via secure file transfer protocol (“SFTP”). The ECP 120 may append customer email addresses to the list of customers.

The system 100 may further comprise an Email Service Provider (“ESP”) 130. The ESP 130 may set up dynamic creative campaigns. An example of an ESP is CheetahMail®, a service provided by Experian Marketing Services of Costa Mesa, Calif. The ECP 120 may transmit a file including the customer email addresses and their respective customer information to the ESP 130. The ESP 130 may match or associate advertising content (e.g., dynamic content) to the list of customers and transmit email offers to at least a portion of the list of customers. The email offers may be partially or fully personalized to the customers. For example, the email offers may be personalized based on travel destination information, travel dates, hotel offers for the travel dates, customer spend capability, customer preferences, customer demographics, etc. For example, if transaction data includes a customer charge for a flight to San Diego on Thursday, the email offer may be personalized to provide a free SeaWorld ticket, if the customer stays over an extra night on Friday night.

As used herein, “match” or “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

The system may be described herein as an email marketing system. However, one skilled in the art will appreciate that similar functionality may provide similar advertising via any other communication means. For example, text, social media (Facebook, Twitter, Snapchat, etc.), instant messaging and/or the like.

In various embodiments, the system 100 may further comprise a customer device 106. The customer device 106 may comprise any device capable of receiving and displaying an electronic message. For example, the customer device 106 may take the form of a computer or processor, or a set of computers/processors, although other types of computing units or systems may be used, including laptops, notebooks, hand held computers, personal digital assistants, cellular phones, smart phones (e.g., iPhone®, BlackBerry®, Droid®, etc.) tablets, wearables (e.g., smart watches and smart glasses), or any other device capable of receiving data over the network 108. The customer device 106 may receive offers from the ESP 130 specifically tailored to a customer based on their customer information, transaction history, and/or individual transaction records.

In various embodiments, a transaction may comprise a record of charge (or “ROC”) comprising transaction data. The ROC may include a unique identifier associated with a transaction. A transaction may, in various embodiments, be performed by one or more customers using a transaction account, such as a transaction account associated with a gift card, a debit card, a credit card, and the like. A ROC may, in addition, contain details such as travel information, location, merchant name or identifier, transaction amount, transaction date, account number, account security pin or code, account expiry date, and the like for the transaction. The TAP server 104 may obtain typical ROC data that is sent with each authorization/transaction.

In various embodiments, the ROC may include travel data. For example, the customer may purchase a flight, and the ROC may include a departure time, date, and/or destination. Similarly, the ROC may include a return time, date, and/or destination.

In various embodiments, each individual transaction record may be transmitted to the TAP server 104, in response to the customer completing a transaction that generates an individual transaction record. The data may also be obtained in batch, periodically, at certain times, etc. The TAP server 104 may store and/or use each individual transaction record in response to receiving the individual transaction records. The TAP server 104 may also store and/or use customer information that was obtained prior to or contemporaneously with individual transaction records. The customer information may include internal data, external data, data obtained from any channel, etc. The TAP server 104 may store individual transaction records and customer information in a database, for example. Transaction information may comprise customer information. The customer may provide customer information (e.g., merchants of interest, gender, age, or other information for use in projecting future purchases by the customer). The transaction information for the customer may be captured by the TAP server 104 in the course of transactions made by the customer.

The customer may open the email offer using the customer device 106. In various embodiments, the customer may opt into a program provided by a transaction account provider to provide transaction information to various third parties and to receive targeted offers via email. The email offer may comprise a header image and customer specific information via data extensions in the HTML code for the email. The customer specific information may relate to a specific transaction. For example, the customer specific information may indicate that the customer purchased a flight for a specific date and location.

The customer specific information may be transmitted to an agile email provider 140. The agile email provider 140 may be a service that is capable of providing live information in an email. An example of an agile email provider is Movable Ink, of New York, N.Y. The agile email provider 140 may connect to an offer provider 150 via an application programming interface (“API”). In various embodiments, the offer provider 150 may be operated by the transaction account provider. For example, the transaction account provider may host a travel website, and the agile email provider 140 may connect to the back end of the travel website using the API. However, in various embodiments, the offer provider 150 may be an unaffiliated third party, and the agile email provider 140 may pull current information from a website of the offer provider 150 using the API. The current information may include current pricing and availability of products and services, such as hotels, car rentals, dinner reservations, sporting event tickets, or other products or services of which price or inventory may change over time.

The information obtained by the agile email provider 140 may be loaded into the email offer on the customer device 106 at the time the email is opened. Each time the email is subsequently opened, the agile email provider 140 may pull and/or receive current information from the offer provider 150 using the API. Thus, regardless of when the email offer is sent or opened by the customer, the email offer will be current when the customer opens the email offer.

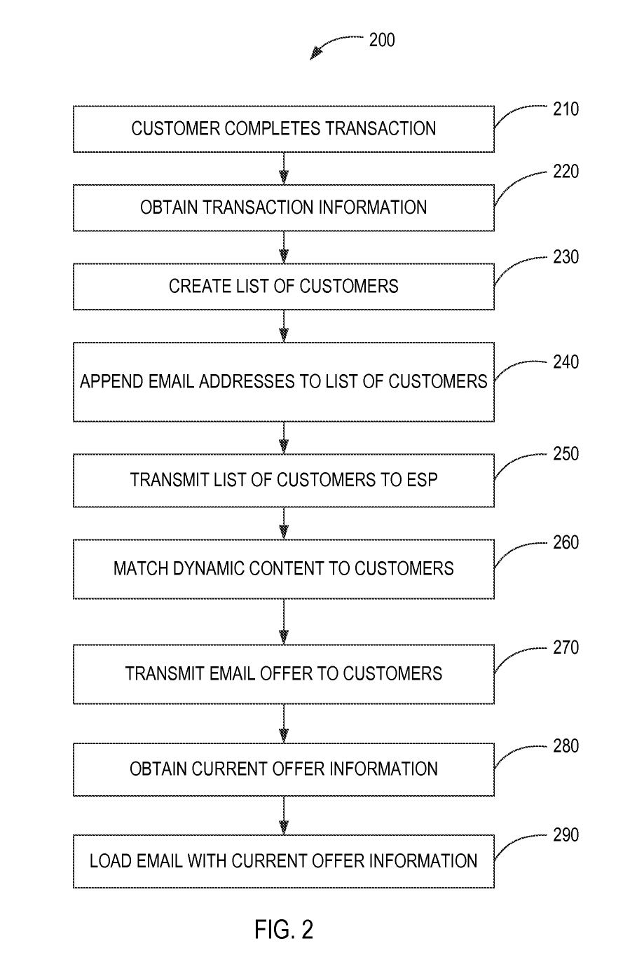

Referring to FIG. 2, a process 200 for delivering targeted refreshable email advertisements is illustrated according to various embodiments. A customer may complete a transaction using a transaction account (step 210). Transaction information for the transaction may be obtained (step 220). In various embodiments, a transaction account provider may obtain the information from a ROC for the transaction. However, in various embodiments, the merchant involved in the transaction or a third party may obtain the transaction information. The transaction account provider may create a list of customers for a marketing campaign based on the transaction information (step 230). In various embodiments, the list of customers may be created based on a type of transaction, customer spend, customer demographic information, travel information, or any other information related to the customers. Email addresses may be appended to the list of customers (step 240). The list of customers may be transmitted to an ESP (step 250). The list of customers and email addresses may be transmitted to the ESP over SFTP. The ESP may match dynamic content to the customer in the list of customers (step 260). For example, based on the ROC, the ESP may determine that the customer is travelling to a city on a specific date, and the ESP may match or associate the customer with offers pertaining to the city on the specific date. The ESP may transmit an email offer to the customers (step 270). The ESP may transmit an email to the customer containing an offer specifically tailored to the customer. The email may comprise data extensions in the HTML code that identify customer information pertaining to the customer. For example, a ROC may indicate that the customer is flying from a departure city to a destination city on a first date, and returning on a second date. The email to the consumer may include offers for merchants in the destination city from the first date to the second date. In various embodiments, the merchants may be selected based on additional information specific to the customer, such as spend capacity. For example, if the customer has a relatively high spend capacity, the selected merchants may be relatively more expensive merchants.

A customer may open the email. In various embodiments, the email may comprise data extensions in HTML code. The data extensions may comprise information specific to the customer. For example, the data extensions may comprise the time and destination of a flight. In response to the customer opening the email, the information in the data extensions is sent to the agile email provider. The agile email provider may connect to a merchant via an API to pull current offers from the merchant.

In response to the customer opening the email, an agile email provider may obtain current offer information from an offer provider (step 280). The customer email may load with the current offer information (step 290).

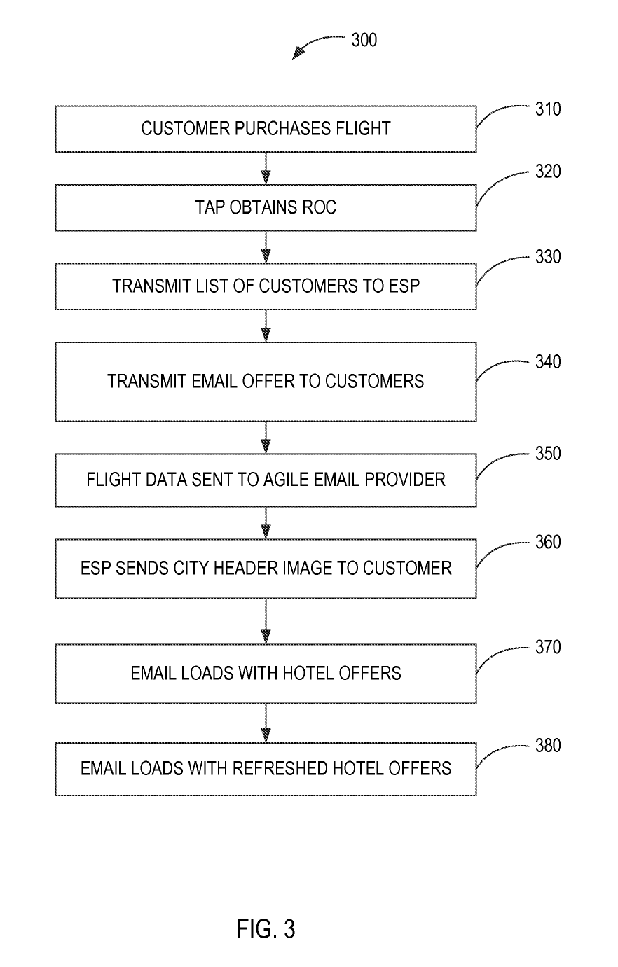

Referring to FIG. 3, an example of a process 300 for delivering targeted refreshable email advertisements is illustrated according to various embodiments. A customer may purchase a flight using a transaction account issued by a transaction account provider (step 310). The transaction account provider may receive the ROC for the transaction (step 320). A ROC for the purchase may include flight data indicating that the customer is travelling from New York to Las Vegas on July 4^{th} and returning on July 8^{th}. The transaction account provider may pull and/or receive customer spend data from a relational database which maintains customer data. The transaction account issuer may determine that the customer has opted in to an email marketing campaign and meets minimum spend criteria. The transaction account issuer may transmit a list of customers including the customer to an Email Communications Platform (ECP) and an ESP via secure file transfer protocol (SFTP) (step 330).

The ESP may match dynamic offers to the list of customers and transmit an offer to the customer via email (step 340). The email may contain the flight data via data extensions in the HTML code. The customer may open the email. At the time of the customer opening the email, the flight data may be sent to an agile email provider, such as Movable Ink (step 350). The ESP may send back the appropriate city header image to the customer (step 360). The agile email provider may connect to a hotel aggregator, such as Orbitz®, via an API and pull top hotel offers available for Las Vegas from July 4^{th} to July 8^{th}. The email may load for the customer including the top hotel offers for Las Vegas (step 370). Each time the customer opens the email, the current hotel offers may be loaded (step 380). Thus, the offers presented to the customer may be different each time the customer opens the email. In this manner, the offers will be current regardless of when, or how many times, the customer opens the email.

Although described herein with primarily with reference to travel information obtained from transaction account transactions, customer information may be obtained from a variety of sources, and may be used to provide a variety of information in an email to a customer which may update in response to the customer opening the email.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YouTube®, AppleTV®, Pandora®, Xbox®, Sony® PlayStation®), a uniform resource locator (“URL”), a document (e.g., a Microsoft Word® document, a Microsoft Excel® document, an Adobe .pdf document, etc.), an “ebook,” an “emagazine,” an application or microapplication (as described herein), an SMS or other type of text message, an email, Facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, Foursquare®, Twitter®, MySpace®, LinkedIn®, and the like. Examples of affiliate or partner websites include American Express®, Groupon®, LivingSocial®, and the like. Moreover, examples of mobile device communications include texting, email, and mobile applications for smartphones.

A “consumer profile,” “customer data,” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT®, Windows 95/98/2000®, Windows XP®, Windows Vista®, Windows 7®, OS2, UNIX®, Linux®, Solaris®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, components, modules, and/or engines of system 100 may be implemented as micro-applications or micro-apps. Micro-apps are typically deployed in the context of a mobile operating system, including for example, a Palm® mobile operating system, a Windows® mobile operating system, an Android® Operating System, Apple® iOS, a Blackberry® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Phrases and terms similar to an “offer” may include any good, service, information, experience, entertainment, data, item, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “cardmember”, “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A computer-implemented method comprising:
obtaining, by a computer-based system, transaction information for a transaction;
transmitting, by the computer-based system, the transaction information to an email communications platform via secure file transfer protocol;
appending, by the computer-based system and at the email communications platform, an email address to the transaction information;
transmitting, by the computer-based system and from the email communications platform to an email service provider, the transaction information and the email address via secure file transfer protocol;
matching, by the computer-based system and by the email service provider, dynamic content with the transaction information;
transmitting, by the computer-based system and from the email service provider, an email offer to a customer, wherein the email offer comprises the transaction information; and
transmitting, by the computer-based system, current offer information to the customer in response to the customer opening the email offer.

2. The method of claim 1, wherein the transaction information comprises a date and location related to the transaction.

3. The method of claim 1, further comprising transmitting, by the computer-based system, a city header in the email offer.

4. The method of claim 1, further comprising creating, by the computer-based system, a list of customers for a marketing campaign based on the transaction information.

5. The method of claim 4, wherein the list of customers is based on at least one of a type of transaction, customer spend, demographic information, or travel information.

6. The method of claim 1, further comprising transmitting, by the computer-based system, the list of customers to the email service provider over SFTP.

7. The method of claim 1, further comprising obtaining, by the computer-based system, the current offer information from a hotel aggregator in response to the customer opening the email offer.

8. An article of manufacture including a non-transitory, tangible computer readable storage medium having instructions stored thereon that, in response to execution by a computer-based system, cause the computer-based system to perform operations comprising:
obtaining, by the computer-based system, transaction information for a transaction;
transmitting, by the computer-based system, the transaction information to an email communications platform via secure file transfer protocol;
appending, by the computer-based system and at the email communications platform, an email address to the transaction information;
transmitting, by the computer-based system and from the email communications platform to an email service provider, the transaction information and the email address via secure file transfer protocol;
matching, by the computer-based system and by the email service provider, dynamic content with the transaction information;
transmitting, by the computer-based system and from the email service provider, an email offer to a customer, wherein the email offer comprises the transaction information; and
transmitting, by the computer-based system, current offer information to the customer in response to the customer opening the email offer.

9. The method of claim 8, wherein the transaction information comprises a date and location related to the transaction.

10. The method of claim 8, further comprising transmitting, by the computer-based system, a city header in the email offer.

11. The method of claim 8, further comprising creating, by the computer-based system, a list of customers for a marketing campaign based on the transaction information.

12. The method of claim 11, wherein the list of customers is based on at least one of a type of transaction, customer spend, demographic information, or travel information.

13. The method of claim 8, further comprising transmitting, by the computer-based system, the list of customers to the email service provider over SFTP.

14. The method of claim 8, further comprising obtaining, by the computer-based system, the current offer information from a hotel aggregator in response to the customer opening the email offer.

15. A system comprising:
a processor,
a tangible, non-transitory memory configured to communicate with the processor,
the tangible, non-transitory memory having instructions stored thereon that, in response to execution by the processor, cause the processor to perform operations comprising:
obtaining, by the processor, transaction information for a transaction;
transmitting, by the processor, the transaction information to an email communications platform via secure file transfer protocol;
appending, by the processor and at the email communications platform, an email address to the transaction information;
transmitting, by the processor and from the email communications platform to an email service provider, the transaction information and the email address via secure file transfer protocol;
matching, by the processor and by the email service provider, dynamic content with the transaction information;
transmitting, by the processor and from the email service provider, an email offer to a customer, wherein the email offer comprises the transaction information; and
transmitting, by the processor, current offer information to the customer in response to the customer opening the email offer.

16. The method of claim 15, wherein the transaction information comprises a date and location related to the transaction.

17. The method of claim 15, further comprising transmitting, by the processor, a city header in the email offer.

18. The method of claim 15, further comprising creating, by the processor, a list of customers for a marketing campaign based on the transaction information.

19. The method of claim 18, wherein the list of customers is based on at least one of a type of transaction, customer spend, demographic information, or travel information.

20. The method of claim 15, further comprising transmitting, by the processor, the list of customers to the email service provider over SFTP.
